(19) United States
(12) Patent Application Publication
(10) Pub. No.: US 2026/0308776 A1
(43) Pub. Date: Oct. 8, 2026

(54) ADDITIVES FOR IMPROVED ELECTROLYZER DURABILITY

(71) Applicant: The Lubrizol Corporation, Wickliffe, OH (US)

(72) Inventors: Thomas S. Corrigan, Lakewood, OH (US); Tyler Petek, Willowick, OH (US); Christopher M. Rasik, Cleveland, OH (US)

(73) Assignee: The Lubrizol Corporation, Wickliffe, OH (US)

(21) Appl. No.: 19/485,006

(22) PCT Filed: May 16, 2024
(86) PCT No.: PCT/US2024/029608

§ 371 Date: Nov. 17, 2025

Related U.S. Application Data
(60) Provisional application No. 63/467,492, filed on May 18, 2023.
(60) Provisional application No. 63/467,494, filed on May 18, 2023.

(51) Int. Cl. C25B 1/50; C25B 1/04; C25B 11/095; C25B 13/08

(52) U.S. Cl. CPC C25B 1/50; C25B 1/04; C25B 11/095; C25B 13/08

(57) ABSTRACT

The disclosed technology relates to a composition for mitigating hydrogen cross-over and for mitigating polymer oxidation by adding radical scavenging organic inhibitors within a proton exchange membrane (“PEM”) electrolyzer.

### BACKGROUND OF THE INVENTION

The disclosed technology relates to a composition for mitigating polymer oxidation by adding radical scavenging organic inhibitors within an electrolyzer employing a proton exchange membrane (“PEM”).

There are many different electrolysis systems. One class of examples where the anode is known to produce radicals, or radical precursors that can generate radicals during electrolysis operation (e.g. hydrogen peroxide), which lead to oxidative degradation is water electrolysis. Another class of electrolysis systems where the anode can produce radicals is CO₂ electrolysis with an anode nominally evolving oxygen from aqueous electrolyte.

One type of water electrolysis system is proton exchange membrane water electrolysis (PEMWE) systems. Water electrolysis systems are a promising source of hydrogen utilizing direct electrical energy but the technology needs to be advanced for them to displace the current steam methane reforming (SMR) means of hydrogen production. Two major issues in water electrolysis are hydrogen cross over and solid ion conducting medium (i.e., ionomer) oxidation.

There is a need for new strategies to extend the durability of ionomers in electrolyzer membranes and electrodes to prolong lifetime against oxidative degradation, as well as to minimize or stop hydrogen cross-over to enable safer operation and more pure product streams.

### SUMMARY OF THE INVENTION

The disclosed technology solves the problem of ionomer degradation in proton exchange membrane (“PEM”) electrolyzer membranes and electrodes by employing redox active molecules in the electrolyzer, either within the membrane, within recombination layers, within electrode layers, and/or within the electrolyzer electrolyte.

The radical scavenging organic inhibitors can be stoichiometric for radical scavenging (i.e. single time use) or can be regenerated to a radical scavenging state (i.e. be reduced) via multiple mechanisms during operation of the electrolyzer including but not limited to oxidation of hydrogen towards hydrogen crossover mitigation, direct reduction at an electrode, or any other chemical or electrochemical operation. The additive can be regenerated to a state where it can scavenge radicals by many mechanisms, including but not limited to hydrogen cross-over mitigation (i.e. oxidation of hydrogen).

Thus, the technology provides, in one aspect, a composition comprising (a)(i) catalyst, (a)(ii) ionomer, or (a)(iii) mixtures of (a)(i) and (a)(ii), and (b) organic inhibitor.

Also provided is a method of extending the lifetime of ionomer in an electrolyzer and preventing hydrogen crossover to the anode. The method includes adding in the electrode, membrane, electrolyte and/or recombination layer of the electrolyzer organic inhibitor, and then operating the electrolyzer.

In another embodiment, the technology includes an electrolyzer having (a) electrodes, (b) membrane, and (c) electrolyte, wherein the electrolyte comprises organic inhibitor.

### DETAILED DESCRIPTION OF THE INVENTION Various preferred features and embodiments will be described below by way of non-limiting illustration.

Unless otherwise stated, all part levels of the ingredients are based on 100 parts by weight of the membrane ionomer, abbreviated as “phr.”

A proton exchange membrane (“PEM”) electrolyzer is an apparatus that produces valuable end products, such as hydrogen or reduced carbon dioxide products such as methane or formate, through an electrochemical process, called electrolysis, capable of producing, for example, hydrogen and oxygen molecules from an electrolyte, such as water, or reduced carbon dioxide products such as methane or formate, using electricity.

PEM electrolyzers include electrodes separated by a membrane and optional recombination layer that may be incorporated in or on the membrane. A voltage or current is applied to the electrodes causing an electric field between the electrodes which causes the break down of the electrolyte into its components, for example, hydrogen and oxygen. A complete system also includes pumps, power electronics, gas separator and other auxiliary components, such as storage tanks.

Many of the components of the PEM electrolyzer, including the electrodes and the membrane, can include a solid ion conducting medium, also referred to as an ionomer. These ionomers are subject to degradation by oxidation. To address such oxidation, organic inhibitors can be included in these layers.

The organic inhibitor is a compound that can mitigate detrimental oxidation of the ionomer material by chemical oxidizing agents, e.g., oxidative attack by peroxide radicals which can be formed during operation. When the chemical oxidizing agents are formed, the organic inhibitor can be chemically oxidized instead of the membrane and/or polymeric material.

In other words, during oxidation events the organic inhibitor will be oxidized instead of the detrimental oxidation of the membrane and/or polymeric material.

The organic inhibitor can have a redox potential greater than the potential of the anode electrode of the electrolyzer. The organic inhibitor must also not poison the catalyst in the electrode or any recombination catalyst present on or in the membrane, i.e. it must not reduce the activity of the catalyst towards oxygen and or hydrogen evolution reactions to detrimental effect.

The organic inhibitor may be a reversible organic inhibitor. That is, after being oxidized, in the oxidized form, a reversible organic inhibitor can be chemically and/or electrochemically reduced back to a form which can again be oxidized to mitigate detrimental oxidation of other components by oxidizing agents. This reversibility between oxidized and reduced states can occur, for example, by reacting with hydrogen that crosses the electrolyzer membrane, or for example, in a reaction catalyzed by a recombination catalyst. Thereby, a reversible organic inhibitor can prevent not only the degradation of the membrane but also cross-over of hydrogen.

The oxidation of a reversible organic inhibitor must also have facile kinetics such that the oxidation of the molecule occurs at appreciable rates before the membrane oxidation events and the molecules subsequent reduction, e.g. by reaction with hydrogen to the an oxidized state, occurs before further subsequent oxidations are required, catalyzed by the recombination catalyst.

One of ordinary skill in the art will readily be able to test for compounds that constitute reversible organic inhibitors according to the techniques described herein. All such reversible organic inhibitors are contemplated under the present disclosure.

Organic inhibitors may be selected from organic antioxidants, such as, for example, arylamines, diarylamines, alkylated arylamines, alkylated diaryl amines, phenols, hindered phenols, sulfurized olefins, sulfur heterocycles, aryl amine heterocycles, terpenes, dithiocarbamates, phosphites, dithio phosphates, hindered amines. Phenolic antioxidants in particular may be employed, such as, for example, simple alkyl phenols, hindered phenols, or coupled phenolic compounds. The hindered phenol antioxidant often contains a secondary butyl and/or a tertiary butyl group as a sterically hindering group. The phenol group may be further substituted with a hydrocarbyl group (typically linear or branched alkyl) and/or a bridging group linking to a second aromatic group. Examples of suitable hindered phenol antioxidants include 2,6-di-tert-butylphenol, 4-methyl-2,6-di-tert-butylphenol, 4-ethyl-2,6-di-tert-butylphenol, 4-propyl-2,6-di-tert-butylphenol or 4-butyl-2,6-di-tert-butylphenol, 4-dodecyl-2,6-di-tert-butylphenol, or butyl 3-(3,5-ditertbutyl-4-hydroxyphenyl)propanoate. In one embodiment, the hindered phenol antioxidant may be an ester.

Coupled phenols often contain two alkylphenols coupled with alkylene groups to form bisphenol compounds. Examples of suitable coupled phenol compounds include 4,4′-methylene bis-(2,6-di-tert-butyl phenol), 4-methyl-2,6-di-tert-butylphenol, 2,2′-bis-(6-t-butyl-4-heptylphenol); 4,4′-bis(2,6-di-t-butyl phenol), 2,2′-methylenebis(4-methyl-6-t-butylphenol), and 2,2′-methylene bis(4-ethyl-6-t-butylphenol).

The diarylamine or alkylated diarylamine may be a phenyl-α-naphthylamine (PANA), an alkylated diphenylamine, or an alkylated phenylnapthylamine, or mixtures thereof. The alkylated diphenylamine may include di-nonylated diphenylamine, nonyl diphenylamine, octyl diphenylamine, di-octylated diphenylamine, di-decylated diphenylamine, decyl diphenylamine and mixtures thereof. In one embodiment, the diphenylamine may include nonyl diphenylamine, dinonyl diphenylamine, octyl diphenylamine, dioctyl diphenylamine, or mixtures thereof. In one embodiment the alkylated diphenylamine may include nonyl diphenylamine, or dinonyl diphenylamine. The alkylated diarylamine may include octyl, di-octyl, nonyl, di-nonyl, decyl or di-decyl phenylnapthylamines.

Examples of further currently known organic inhibitors include many hydroquinones/quinones, such as, for example, potassium 1,4-hydroquinonesulfonate; methyl 2,5-dihydroxybenzoate; 2,5-dihydroxybenzoic acid; 2,5-dihydroxybenzoic acid; 2,5-dimethoxybenzonitrile; 3,6-dihydroxyphthalonitrile; 3,4-dihydroxybenzoic acid; 2,3-Dichloro-5,6-dicyano-1,4-benzoquinone.

The solid ion conducting medium of the electrode and/or membrane layer can be an ionomer polymer binder. The ionomer of a PEM electrolyzer can be any polymer that can transport cations (e.g., H+) to and from reaction sites within the electrolyzer. “Reaction sites” are catalyst sites in the electrolyzer, such as in the electrodes or recombination layer. Generally, the solid ion conducting medium, or ionomer, conducts positive ions (e.g., protons).

In PEM electrolyzers any cationic, or proton, conducting polymer can be employed as the ionomer in the electrodes and membrane and typically include those having anionic functional groups bound to a common backbone, which are typically sulfonic acid groups, but may also include carboxylic acid groups, imide groups, amide groups, or other acidic functional groups. Backbone polymers can include, for example, hydrocarbon polymers, chitosan, poly (ethylene glycol), poly (vinyl alcohol), poly (vinylpyrrolidone), poly (2-acrylamido-2-methyl-1-propanesulfonic acid) and poly (styrene) sulfonic acid. An example of proton conducting polymers commonly employed as ionomers and suitable in the present invention are sulfonic acid polymers. Sulfonic acid polymers are widely discussed in the literature and are not particularly limited here. Examples of sulfonic acid polymers include any sulfonate ion exchange polymer, which is to say, polymers containing sulfonic acid moieties. Sulfonic acid polymers can include, but are not limited to, perfluorosulfonic acid polymers, sulfonated poly(benzimidazole) polymer, sulfonated poly(arylene ethers) polymers, sulfonated poly(ether ether ketone) polymer, sulfonated polyvinyl chloride, 2-acrylamido-2-methylpropane sulfonic acid (AMPS), and poly(styrene sulfonate) (block co) polymer, as examples, but the sulfonic acid could be any other sulfonic acid polymer now known or developed in the future. Other examples of ionomers can include sulfonated polybenzimidazole polymers, carboxylic acid polymers, phosphonic acid polymers, phosphoric acid doped polymers, and the like. The ionomer polymer binder is not limited and may be any proton conducting polymer now known or developed in the future.

The electrode and membrane layer of the PEM electrolyzer can also include a non-ionically conductive material to help maintain the integrity of the electrode and/or membrane layer. Examples of non-ionically conductive materials can include polymers such as polyvinyl alcohol, polyacrylate, polymethacrylate, functionalized polyethylene oxides, functionalized polypropylene oxides; thermoplastic polyurethanes, polytetrafluoroethylene, to name a few. Here again, the non-ionically conductive materials are not limited and may be any material now known or developed in the future to help maintain the integrity of the membrane layer.

The conductive electrodes, or simply electrodes may also include an ionomer binder and/or non-ionically conductive material as described above, as well as an optional organic inhibitor.

The electrodes will additionally include electrode catalyst. The catalyst can be any of the now known or later developed electrode catalysts, including metal or non-metal catalysts. The metal catalyst can be, for example, a noble metal or transition metal or an alloy of any thereof. Examples of such metals include, for example, ruthenium, rhodium, palladium, osmium, iridium, platinum, gold, silver, copper, rhenium, mercury, iron, cobalt, and nickel. In an embodiment, the metal catalyst is a platinum or platinum alloy.

The conductive electrodes will also include at least one solid ion conducting medium to bind the catalyst together and transport protons (i.e., H+) to and from reaction sites within the particular electrode (anode or cathode), as well as help to disperse the electrode components. Any solid ion conducting polymer can be employed as the ionomer, such as those polymers described above.

With respect to the catalyst in particular, there is an alternative embodiment to simply mixing the catalyst and organic inhibitor with the ionomer. In the alternative embodiment, the organic inhibitor can be immobilized by functionalization onto the ionomer, followed by mixing the functionalized ionomer with the catalyst, and optionally a non-ionically conductive material. The entire mixture may be mixed with the solvent to prepare the ink as well.

The amount of organic inhibitor in an electrode layer, when present, can range from 1 phr to 50 phr based on the total electrode catalyst content of the electrode, or from 2 phr to 40 phr based on the total electrode catalyst content, or even from 3 phr to 37 phr based on the total electrode catalyst content, or from 4 phr to 35 phr based on the total electrode catalyst content, or even 5 phr to 34 phr based on the total electrode catalyst content of the electrode.

The membrane layer of an electrolyzer is made up of the ion conducting medium described above as well, serving multiple functions including transport of ions and separation of anode and cathode electrodes.

The amount of organic inhibitor, when present in the membrane layer, can range from 0.1 to 25 mol %, relative to the ionic moiety in the ionomer, or from 0.2 to 20 mol % relative to the ionic moiety in the ionomer, or from 0.3 to 15 mol % relative to the ionic moiety in the ionomer, or from 0.4 to 10 mol % relative to the ionic moiety in the ionomer, or from or 0.5 to 5 mol % relative to the ionic moiety in the ionomer.

The membrane layer can also include a metal or non-metal hydrogen recombination catalyst on which the oxidation of hydrogen is promoted (also referred to as a “recombination catalyst” or simply “catalyst”). The metal hydrogen recombination catalyst can be a noble metal or transition metal or an alloy of any thereof. Examples of such metals include, for example, ruthenium, rhodium, palladium, osmium, iridium, platinum, gold, silver, copper, rhenium, mercury, iron, cobalt, and nickel. In an embodiment, the metal recombination catalyst is a platinum or platinum alloy. This recombination catalyst serves to consume the hydrogen crossing through the separator from the hydrogen producing side to the oxygen producing side of the system.

In one embodiment, the technology provides a composition containing a recombination catalyst and a reversible organic inhibitor. The combination of the recombination catalyst and the reversible organic inhibitor are contained within the membrane and not in explicit contact with the electrode. This could be a discrete continuous layer within the membrane or a randomized dispersion throughout the membrane. The recombination catalyst and the reversible organic inhibitor may be simply mixed together and in physical contact, or the reversible organic inhibitor may be immobilized onto the recombination catalyst. Immobilization may be, for example, by covalent bonding of the reversible organic inhibitor to the recombination catalyst and/or organic species comprising the catalyst layer by methods known in the art.

With respect to the recombination catalyst in particular, there is an alternative embodiment to first preparing the recombination catalyst and reversible organic inhibitor. In alternative embodiments, the reversible organic inhibitor can be immobilized by functionalization onto the ionomer, followed by mixing the functionalized ionomer with the recombination catalyst, or the reversible organic inhibitor can be immobilized by functionalization onto the recombination catalyst, followed by mixing the functionalized ionomer with the ionomer, in each case optionally with a non-ionically conductive material.

The amount of reversible organic inhibitor, when present in the membrane recombination layer can range from 1 phr to 50 phr based on the total recombination catalyst content, or from 2 phr to 40 phr based on the total recombination catalyst content, or even from 3 phr to 37 phr based on the total recombination catalyst, or from 4 phr to 35 phr based on the total recombination catalyst content, or even 5 phr to 34 phr based on the total recombination catalyst content.

A PEM electrolyzer will include electrodes, membrane, and electrolyte. Electrolytes are conductors of ions and can include any now known or future developed electrolyte. Example electrolytes include for purposes here water, which can carry the organic inhibitor through the system.

In an embodiment, the technology encompasses an electrolyzer having (a) electrodes, (b) membrane, and (c) electrolyte, wherein the electrolyte contains organic inhibitor.

In one embodiment, the present technology provides an ionomer additive composition. The ionomer additive composition can include the ionomer, optional non-ionically conductive material, organic inhibitor.

In one embodiment, the present technology provides an ionomer additive composition. The ionomer additive composition can include the ionomer, recombination catalyst, optional non-ionically conductive material, and organic inhibitor.

In one embodiment, the present technology provides an electrode composition. The electrode composition can include ionomer, optional non-ionically conductive material, organic inhibitor and electrode catalyst.

The technology also includes a method of prevent ionomer degradation of ionomer in electrolyzer. The method includes adding organic inhibitor in the electrolyzer, and operating the electrolyzer.

The present technology allows for a method of preventing oxidation of an ionomer and prevention of hydrogen cross-over within an electrolyzer, by including in the membrane layer of the electrolyzer organic inhibitor, and operating the electrolyzer.

Also included is a method of extending the lifetime of ionomer and or membrane material in an electrolyzer by adding organic inhibitor into an electrolyte put into the electrolyzer, and operating the electrolyzer.

The amount of each chemical component described is presented exclusive of any solvent or diluent, which may be customarily present in the commercial material, that is, on an active chemical basis, unless otherwise indicated. However, unless otherwise indicated, each chemical or composition referred to herein should be interpreted as being a commercial grade material which may contain the isomers, by-products, derivatives, and other such materials which are normally understood to be present in the commercial grade.

It is known that some of the materials described above may interact in the final formulation, so that the components of the final formulation may be different from those that are initially added. For instance, metal ions can migrate to other acidic or anionic sites of other molecules. The products formed thereby, including the products formed upon employing the composition of the present invention in its intended use, may not be susceptible of easy description. Nevertheless, all such modifications and reaction products are included within the scope of the present invention; the present invention encompasses the composition prepared by ad-mixing the components described above.

Except where otherwise explicitly indicated, all numerical quantities in this description specifying amounts of materials, reaction conditions, molecular weights, number of carbon atoms, and the like, are to be understood as modified by the word “about.” It is to be understood that the upper and lower amount, range, and ratio limits set forth herein may be independently combined. Similarly, the ranges and amounts for each element of the invention can be used together with ranges or amounts for any of the other elements.

As used herein, the transitional term “comprising,” which is synonymous with “including,” “containing,” or “characterized by,” is inclusive or open-ended and does not exclude additional, un-recited elements or method steps. However, in each recitation of “comprising” herein, it is intended that the term also encompass, as alternative embodiments, the phrases “consisting essentially of” and “consisting of,” where “consisting of” excludes any element or step not specified and “consisting essentially of” permits the inclusion of additional un-recited elements or steps that do not materially affect the essential or basic and novel characteristics of the composition or method under consideration.

While certain representative embodiments and details have been shown for the purpose of illustrating the subject invention, it will be apparent to those skilled in this art that various changes and modifications can be made therein without departing from the scope of the subject invention. In this regard, the scope of the invention is to be limited only by the following claims.

1. A composition comprising (a)(i) catalyst, (a)(ii) ionomer, or (a)(iii) mixtures of (a)(i) and (a)(ii), and (b) organic inhibitor.

2. The composition of claim 1, wherein the organic inhibitor comprises an organic inhibitor which can be cycled between oxidized and reduced states, i.e. a reversible organic inhibitor.

3. The composition of claim 2, wherein the organic inhibitor is reversible by chemical mechanisms.

4. The composition of claim 2, wherein the organic inhibitor is reversible by electrochemical mechanisms.

5. The composition of a claim 1, wherein the organic inhibitor comprises a substance that decomposes peroxides.

6. The composition of claim 1, wherein the organic inhibitor comprises a radical scavenger.

7. The composition of claim 1, wherein the organic inhibitor can oxidize hydrogen either chemically or drives electrochemical hydrogen oxidation.

8. The composition of claim 1, wherein the ionically conductive ionomer conducts cationic species.

9. The composition of claim 1, further comprising a non-ionically conductive material.

10. The composition of claim 1 wherein the catalyst is a recombination catalyst.

11. The composition of any previews claim 1, wherein the recombination catalyst comprises a noble metal.

12. (canceled)

13. (canceled)

14. The composition of claim 1, wherein the recombination catalyst comprises a transitional metal.

15. (canceled)

16. (canceled)

17. (canceled)

18. (canceled)

19. The composition of claim 1, wherein the catalyst is an electrode catalyst.

20. (canceled)

21. (canceled)

22. (canceled)

23. (canceled)

24. (canceled)

25. (canceled)

26. (canceled)

27. (canceled)

28. The composition of claim 1, wherein the organic inhibitor is immobilized by functionalization onto the ionomer.

29. A method of preventing degradation of an ionomer in an electrolyzer, comprising including in the electrolyzer an organic inhibitor, and operating the electrolyzer.

30. The method of claim 29 wherein the organic inhibitor is included in the membrane layer of the electrolyzer.

31. (canceled) The method of claim 29 wherein the membrane comprises recombination catalyst.

32. The method of claim 29 wherein the organic inhibitor is included in an electrode of the electrolyzer.

33. The method of claim 29 wherein the organic inhibitor is included in an electrolyte circulating through the electrolyzer.

34. A method for preventing hydrogen crossover in an electrolyzer comprising including in the recombination layer of the electrolyzer an organic inhibitor, and operating the electrolyzer.

35. An electrolyzer comprising (a) electrodes, (b) membrane, and (c) electrolyte, wherein the electrolyte comprises organic inhibitor.

36. A method of extending the lifetime of ionomer and or membrane material in an electrolyzer comprising adding organic inhibitor into an electrolyte put into the electrolyzer, and operating the electrolyzer.

37. The method of claim 36 wherein the organic inhibitor comprises a substance that decomposes peroxides.

38. The method of claim 36, wherein the organic inhibitor comprises a radical scavenger.
